(19) United States
(12) Patent Application Publication
(10) Pub. No.: US 2026/0116260 A1
(43) Pub. Date: Apr. 30, 2026

(54) VEHICLE

(71) Applicant: TOYOTA JIDOSHA KABUSHIKI KAISHA, Toyota-shi (JP)

(72) Inventor: Hiroto AMADA, Nagakute-shi (JP)

(73) Assignee: TOYOTA JIDOSHA KABUSHIKI KAISHA, Toyota-shi (JP)

(21) Appl. No.: 19/347,905

(22) Filed: Oct. 2, 2025

(30) Foreign Application Priority Data
Oct. 28, 2024 (JP) 2024-189014

(51) Int. Cl. B60L 58/27

(52) U.S. Cl. CPC B60L 58/27; B60L 2240/545; B60L 2240/60; B60L 2260/56

(57) ABSTRACT

When the destination is a battery charging facility (EVSE2), ECU acquires the first traveling time of the vehicle 1 from the current location to EVSE2 from the automotive navigation system, and calculates the second traveling time of the vehicle 1 required to reach the target temperature of the battery suitable for charging in EVSE2 by the heat generation of the battery by the traveling of the vehicle 1. ECU controls the temperature raising device to be in a ON condition based on a comparison between the first traveling time and the second traveling time.

### CROSS-REFERENCE TO RELATED APPLICATION

This application claims priority to Japanese Patent Application No. 2024-189014 filed on October 28, 2024. The disclosure of the above-identified application, including the specification, drawings, and claims, is incorporated by reference herein in its entirety.

### BACKGROUND

### 1. Technical Field

The present disclosure relates to a vehicle.

### 2. Description of Related Art

US Patent No. 10931124 discloses technology in which an automotive navigation system sets a charging facility as a destination when a shortage of State Of Charge (SOC) is predicted in a vehicle that is driven by electric power from a battery, and also adjusts a battery temperature such that temperature of the battery will reach a target temperature that is appropriate for charging when the vehicle arrives at the charging facility and performs charging.

### SUMMARY

However, in the technology that is disclosed in US Patent No. 10931124, the battery temperature is adjusted to reach the target temperature based on distance to the destination. Accordingly, the arrival at the destination may be delayed due to unanticipated traffic congestion, for example, and the battery may reach the target temperature at a timing earlier than expected. This concept of the time regarding traffic congestion is not taken into consideration, and accordingly, in this case there is a need to keep the battery warm until the destination is reached, which can wastefully consume electric power.

An object of the present disclosure is to provide technology that is capable of controlling battery temperature of a vehicle such that wasteful electric power consumption does not occur.

A vehicle according to the present disclosure includes a battery, a drive unit, a temperature raising device, a control device, and an automotive navigation system. The battery is externally chargeable. The drive unit drives the vehicle by electric power of the battery. The temperature raising device raises temperature of the battery. The control device controls the temperature raising device. The automotive navigation system performs guidance regarding a travel route and traveling time of the vehicle, from a current location to a destination. When the destination is a charging facility of the battery, the control device acquires, from the automotive navigation system, a first traveling time of the vehicle from the current location to the charging facility, and also calculates a second traveling time of the vehicle for the battery to reach a target temperature that is appropriate for charging in the charging facility, by heat generation of the battery due to the vehicle traveling. The control device controls the temperature raising device to be in an on state based on results of comparison between the first traveling time and the second traveling time.

In this way, control of the temperature rise of the battery can be performed, taking into in consideration a balance between the first traveling time to the charging facility, taking into account traffic congestion and so forth, and the second traveling time necessary to reach the target temperature. Accordingly, the temperature of the battery can be controlled so as to reach the target temperature in accordance with the timing of arrival at the charging facility. This enables the battery temperature of the vehicle to be controlled such that wasteful electric power consumption does not occur.

Preferably, the control device controls the temperature raising device to the on state when a value that is obtained by adding a first adjustment time to the first traveling time is smaller than a value of the second traveling time. In this way, in a case in which determination is made that the charging facility will be arrived at before the traveling time necessary to reach the target temperature of the battery elapses (in which first traveling time is adjusted to a longer side by an amount that is equivalent to first adjustment time), the control device raises the temperature of the battery. Thus, a situation of arriving at the charging facility before the target temperature is reached can be suppressed.

Preferably, the control device controls the temperature raising device to an off state when a value that is obtained by subtracting a second adjustment time from the first traveling time is greater than the second traveling time. In this way, in a case in which determination is made that the target temperature will be reached before arriving at the charging facility (in which first traveling time is adjusted to a shorter side by an amount that is equivalent to second adjustment time), the temperature of the battery is not raised, and wasteful electric power consumption can be kept from occurring. When sudden traffic congestion, rerouting, or the like occurs and the first traveling time is prolonged, temperature raising of the battery can be temporarily stopped by the determination of (3) above even when the temperature of the battery is being raised due to the determination of (2) above. Also, in a case in which the first traveling time is shortened due to the traffic congestion being resolved, or rerouting or the like occurring, the temperature of the battery can be immediately raised by the determination of (2) above, even in a case in which the temperature of the battery is not being raised due to the determination of (3) above.

Preferably, the control device maintains a current state of the temperature raising device when the value that is obtained by adding the first adjustment time to the first traveling time is the second traveling time or greater, and also the value that is obtained by subtracting the second adjustment time from the first traveling time is the second traveling time or smaller. When the first traveling time frequently fluctuates due to changes in traffic conditions such as a traffic congestion, there is a possibility that the on/off state of the temperature raising device will frequently switch according to determination that is made in (2) and (3) above. However, the configuration described in (4) above enables such frequent switching to be suppressed in a range of the first adjustment time + the second adjustment time.

Preferably, the control device periodically acquires the first traveling time to be recalculated by the automotive navigation system and also recalculates the second traveling time. The control device updates the state of the temperature raising device based on the first traveling time and the second traveling time that are recalculated. By doing so, the first traveling time is constantly recalculated according to the current position of the vehicle, and the second traveling time is constantly recalculated according to the current battery temperature, and accordingly the state of the temperature raising device can be appropriately updated in accordance with the situation. Thus, depending on the situation, when determination is made that raising the temperature is necessary to reach the target temperature, the temperature raising device is controlled to the on state, and when determination is made that raising the temperature is not necessary to reach the target temperature, the temperature raising device is controlled to the off state. Accordingly, the temperature raising device is controlled to reach the target temperature as close to the vicinity of the destination as possible, without unnecessarily controlling the temperature raising device to the on state. Hence, the battery temperature of the vehicle can be controlled such that wasteful electric power consumption does not occur.

According to the present disclosure, battery temperature of a vehicle can be controlled such that wasteful power consumption does not occur.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a vehicle according to the present embodiment;

FIG. 2 is a diagram for explaining a change in temperature of a battery;

FIG. 3 is a flowchart illustrating an exemplary process performed by the automotive navigation system; and

FIG. 4 is a flowchart illustrating an exemplary process executed by ECU.

### DETAILED DESCRIPTION OF EMBODIMENTS

Hereinafter, embodiments of the present disclosure will be described in detail with reference to the drawings. It should be noted that the same or corresponding portions in the drawings are designated by the same reference signs and repetitive description will be omitted.

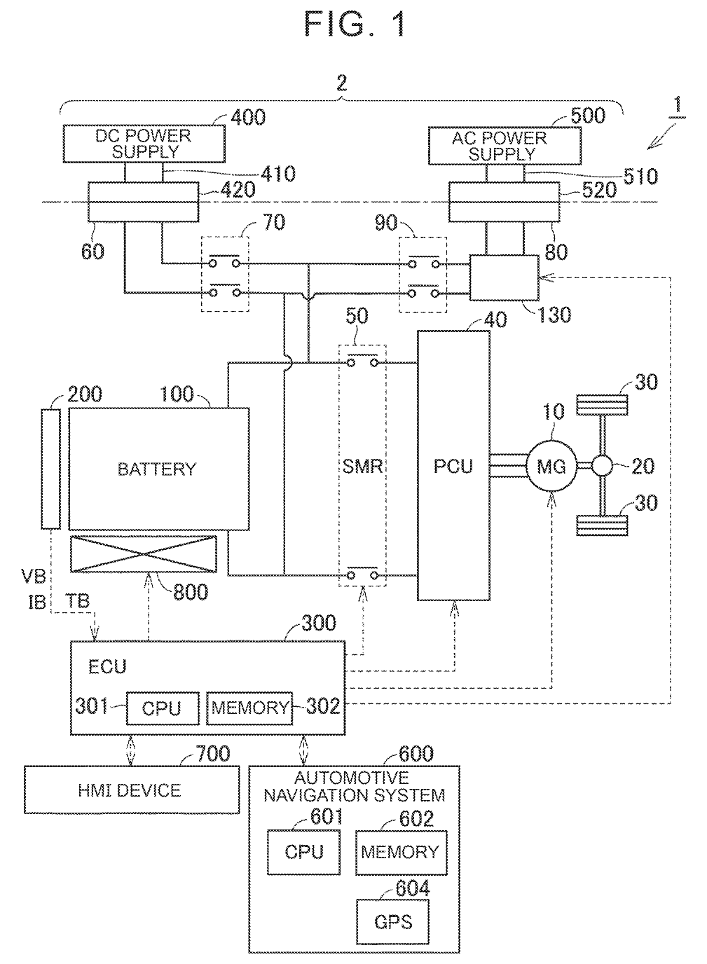

FIG. 1 is a schematic configuration diagram of a vehicle 1 according to the present embodiment. In this embodiment, the vehicles 1 are electrified vehicle, for example battery electric vehicle (BEV: Battery Electric Vehicle). The vehicles 1 may be plug-in hybrid electric vehicle (PHEV: Plug-in Hybrid Electric Vehicle).

The vehicle 1 includes a motor generator (MG: Motor Generator) 10, power transmission gears 20, drive wheels 30, a power control unit (PCU: Power Control Unit) 40, a system main relay (SMR: System Main Relay) 50, a battery 100, a monitoring unit 200, and a control device (ECU: Electronic Control Unit) 300.

MG10 has a function as an electric motor and a function as a generator. The output-torque of MG10 is transmitted to the drive wheels 30 via the power transmission gears 20 including a speed reducer, a differential, and the like. MG10 is an aspect of a drive unit. MG10 drives the vehicles 1 by the electric power of the battery 100.

When the vehicle 1 is braked, the MG 10 is driven by the drive wheels 30 and the MG 10 operates as a power generator. Regenerated electric power generated by regenerative braking force in the MG 10 is stored in the battery 100.

The PCU40 is a power conversion device that bidirectionally converts electric power between the MG 10 and the battery 100. The PCU40 includes an inverter and a converter that operate, for example, based on a control signal from the ECU 300.

The SMR 50 is electrically connected to power lines connecting the battery 100 and the PCU 40. When SMR50 is ON in response to a control signal from ECU300 and is conductive, power may be exchanged between the battery 100 and PCU40. On the other hand, when SMR50 is turned OFF and the battery 100 is disconnected from PCU40, the battery is disconnected.

The battery 100 is externally chargeable and stores electric power for driving MG10. The battery 100 is a secondary battery, and is an assembled battery composed of a plurality of unit cells (battery cells). The unit cell is composed of, for example, a lithium-ion battery, may be a nickel metal hydride battery, or may be an all-solid-state battery.

The monitoring unit 200 includes a voltage detection unit (not shown), a current sensor, and a temperature detection unit. The voltage detector detects a voltage VB of the battery. The current sensor detects a current IB input to and output from the battery 100. The temperature detector detects a temperature TB of the battery 100. The monitoring unit 200 calculates SOC (State of Charge) of the battery 100. SOC may be calculated by, for example, a Coulomb counting method, a SOC-OCV (OpenCircuitVoltage) property, or a combination thereof. The voltage VB, the temperature TB, and the current IB, SOC are outputted to ECU300.

The vehicle 1 includes a DC inlet 60 and a AC inlet 80 and can charge (externally charge) the battery 100 from a charging facility (EVSE: Electric Vehicle Supply Equipment) 2 such as an external DC power supply 400 or an external AC power supply 500. When the connector 420 provided at the end of the charging cable 410 of the external DC power supply (EVSE) 400 is connected to DC inlet 60, the charging relay 70 is controlled to be connected, and external charging (quick charging) of the battery 100 is performed.

The in-vehicle charger 130 converts AC power supplied from an external AC power source into DC power when the connector 520 provided at the end of the charging cable 510 of the external AC power source (EVSE) 500 is connected to AC inlet 80. The DC power output from the in-vehicle charger 130 is supplied to the battery 100 via the charging relay 90, and external charging (normal charging) of the battery 100 is performed.

ECU300 includes CPU (Central Processing Unit) 301 and memories 302. ECU300 controls the respective devices so that the vehicles 1 are in a desired condition based on the signals received from the monitoring unit 200, the signals from various sensors (not shown) (e.g., throttle valve opening degree signal, vehicle speed signal, and the like), the maps and programs stored in the memories 302, and the like. ECU300 also controls the temperature raising device 800.

The automotive navigation system 600 guides the travel route and the traveling time of the vehicle 1 from the current position to the destination. The automotive navigation system 600 calculates the current position (vehicle position) on the basis of the map data including information such as the position of EVSE2 and information such as outputting, and GPS (Global Positioning System) information. The automotive navigation system 600 includes a CPU601 similar to that of ECU300, a memory 602, a GPS604, and the like, and is realized by executing a program stored in the memory 602. The automotive navigation system 600 guides a route to a destination set by the user. It is also possible to set a via point on a route to a destination. The map data may be acquired by communication from an external server.

HMI (Human Machine Interface) The device 700 includes an input device and a display device. The input device and the display device may be a touch panel display. The touch panel display may also serve as an input device and a display device of the automotive navigation system 600.

The vehicle 1 includes a temperature raising device 800. The temperature raising device 800 heats (raises) the battery 100. The temperature raising device 800 may be an electric heater that uses the power of the battery 100. Further, the battery 100 may be heated or cooled by a heat exchange system that exchanges heat with the battery 100.

When the battery 100 is externally charged, the electric power (allowable electric power) that the battery 100 can accept varies according to the temperature TB, and a temperature range suitable for charging exists in the temperature TB. Therefore, when the temperature TB is low, it is desirable to raise the temperature of the battery 100 so that the temperature TB becomes an appropriate temperature (target temperature Tbt) at the beginning of the external charge. The battery 100 generates heat (self-heating) by performing charging and discharging, and the thermal TB increases. In view of the heat generation of the battery 100, the temperature raising device 800 is controlled so that the temperature TB becomes an appropriate temperature (target temperature Tbt) when the external charge is started. In the target temperature Tbt, a target battery temperature for optimally performing charging is set based on the system power of the charging facility.

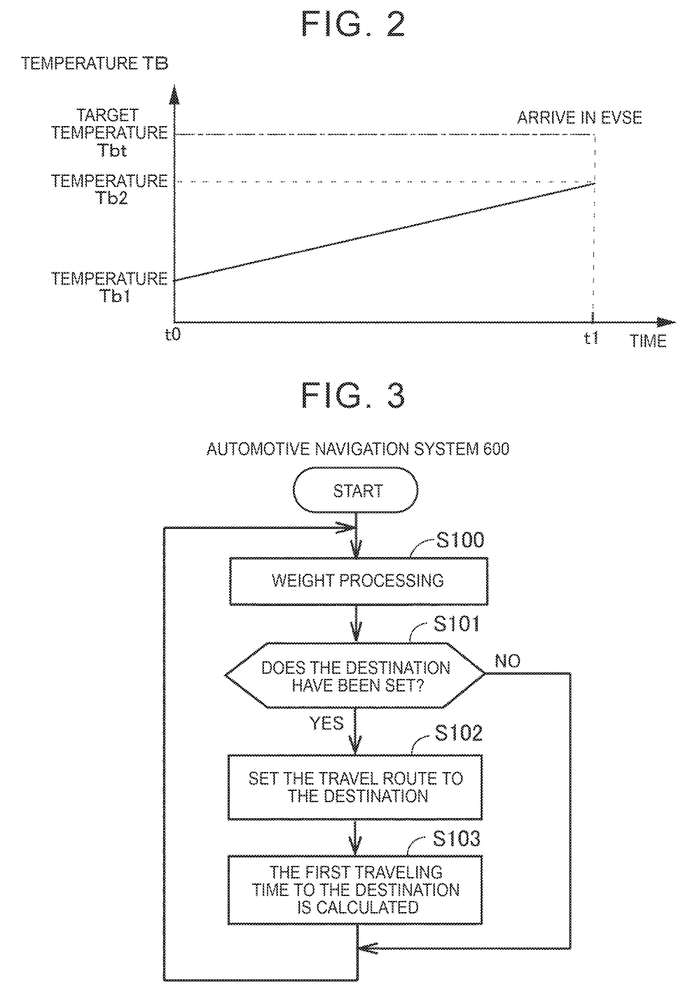

FIG. 2 is a diagram for explaining a change in the thermal TB of the battery 100. In FIG. 2, the vertical axis represents a thermal TB, and the horizontal axis represents times. It is assumed that the temperature TB of the battery 100 is the temperature Tb1 at the time t0 at which the vehicle 1 starts traveling. In the time t1, it is assumed that it is scheduled to arrive at EVSE2. Assume that when arriving at EVSE2, the temperature TB reaches the temperature Tb2 (< target temperature Tbt) due to heat generation (self-heating) of the battery 100. In this case, since the temperature TB does not reach the target temperature Tbt, the temperature TB needs to reach the target temperature Tbt by controlling the temperature raising device 800 to ON state.

FIG. 3 is a flowchart illustrating an example of a process executed by the automotive navigation system 600. Hereinafter, the step is abbreviated as "S".

In S100, the automotive navigation system 600 executes the wait process so that S103 process is executed from S101 at regular intervals. For example, in the weight processing (S100), the processing proceeds to S101 when a predetermined period (for example, a 100 msec) has elapsed from the time when the processing of S101 was performed last time.

In S101, the automotive navigation system 600 determines whether or not the destination is set from the input device (touch-up display) of HMI device 700. The automotive navigation system 600 advances the process to S102 if it is determined YES in S101 and returns the process to S100 if it is determined NO in S101.

In S102, the automotive navigation system 600 determines a travel route from the current location to the set destination and sets the determined travel route. In S103, the automotive navigation system 600 calculates the traveling time from the current location to the destination as the first traveling time and returns the process to S101.

As described above, the process from S101 to S103 is periodically executed, so that the first traveling time from the current position to the destination, which changes once a moment, is periodically updated. In addition, in a case where the travel route is changed, or in a case where the traffic condition changes due to a traffic jam or the like, the first traveling time changes accordingly.

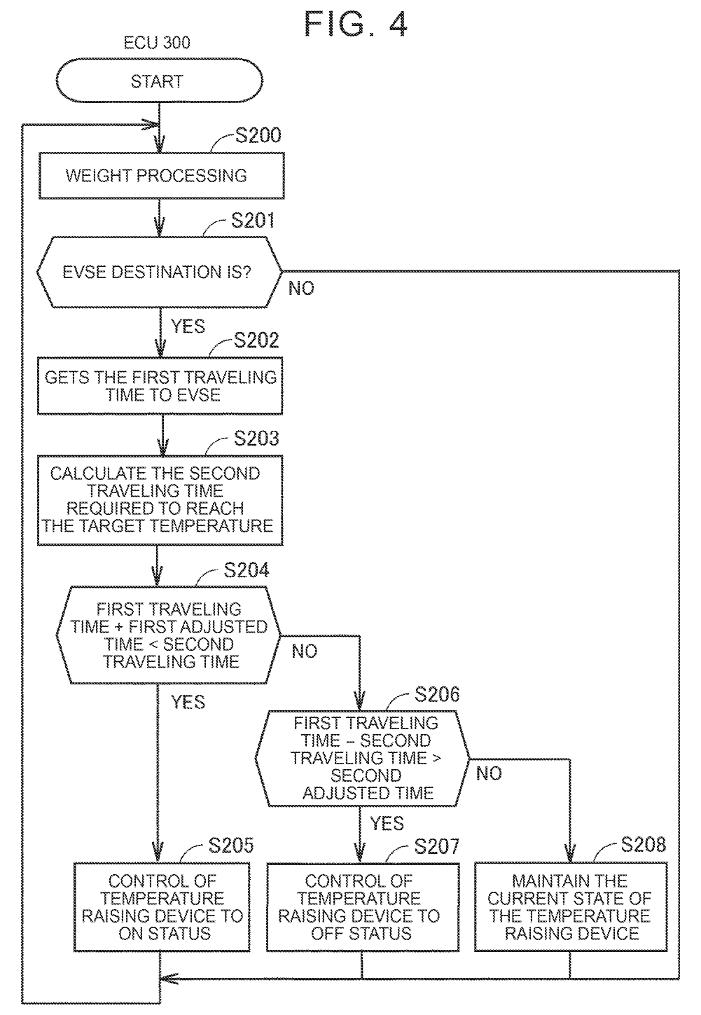

FIG. 4 is a flowchart illustrating an exemplary process executed by ECU300. ECU300 executes a wait process in S200. Similar to S100, the wait process is executed so that the process of S208 from S201 is executed at every fixed cycle (for example, 100 msec).

ECU300 acquires from the automotive navigation system 600, a first traveling time of the vehicle 1 from the current position to EVSE2 when the destination is a EVSE2 which is a charging facility of the battery 100. ECU300 calculates the second traveling time of the vehicle 1 required to reach the target temperature of the battery 100 suitable for charging in EVSE2 by the heat generation of the battery 100 caused by the travel of the vehicle 1. ECU300 controls the temperature raising device 800 to be in a ON condition based on a comparison between the first traveling time and the second traveling time.

As described above, the temperature rise control of the battery 100 can be performed in consideration of the balance between the first traveling time up to EVSE2 in which the traffic jam or the like is taken into consideration and the second traveling time required to reach the target temperature. Therefore, the temperature of the battery 100 can be controlled to reach the target temperature in accordance with the timing of arriving at EVSE2. This makes it possible to control the battery temperature of the vehicle 1 so as not to cause wasteful power consumption.

As follows; In S201, ECU300 determines whether or not a EVSE2 is set as a destination of the automotive navigation system 600. The location where EVSE is provided may be a location previously registered by the operator with the automotive navigation system, for example, a home, a parking lot of a workplace, a parking lot of a commercial facility, or the like. Further, it may be a place stored in the map data, such as a public charging station, a member system charging station, or the like. ECU300 advances the processing to S202 when it is determined that YES is detected in S201 and returns the processing to S200 when it is determined that NO is detected in S201.

ECU300 acquires from the automotive navigation system 600, a first traveling time from the current location to EVSE2 in S202. The first traveling time is a value calculated by S103 and is a periodically updated value.

ECU300 calculates, in S203, the traveling time of the vehicles 1 required to reach the target temperature Tbt from the present temperature TB of the battery 100 as the second traveling time. It is assumed that the target-temperature Tbt is recorded in advance in the memory 302. The second traveling time may be calculated by using various status values of the battery 100, the temperature raising device 800, and the like on the basis of a difference between the present temperature of the battery 100 and the target temperature Tbt.

ECU300 periodically acquires the first traveling time recalculated by the automotive navigation system 600 from S200 by repeating S208 process and recalculates the second traveling time. ECU300 updates the state of the temperature raising device 800 to ON state or OFF state, as shown below, based on the recalculated first traveling time and second traveling time.

ECU300 determines, in S204, whether or not the first traveling time the first adjusting time<the second traveling time. ECU300 advances the process to S205 when it is determined that YES is present in S204 and advances the process to S206 when it is determined that NO is present in S204.

In S205, ECU300 controls the temperature raising device 800 to ON condition and returns the process to S200. As described above, ECU300 controls the temperature raising device 800 to be in ON mode when the first traveling time plus the first adjusting time is smaller than the second traveling time (hereinafter, this process is referred to as "process A"). In this way, ECU300 raises the temperature of the battery 100 when it is determined that EVSE2 arrives prior to the elapse of the second traveling time required to reach the target temperature (however, the first traveling time is adjusted by the first adjustment time and more). Therefore, it is possible to suppress EVSE2 from reaching the target temperature.

ECU300 determines, in S206, whether the first traveling time-the second adjusted time>the second traveling time. ECU300 advances the process to S207 when it is determined that YES is present in S206, and advances the process to S208 when it is determined that NO is present in S206.

In S207, ECU300 controls the temperature raising device 800 to OFF condition and returns the process to S200. As described above, ECU300 controls the temperature raising device 800 to be in OFF mode when the first traveling time minus the second adjusting time is larger than the second traveling time (hereinafter, this process is referred to as "process B").

In this way, when it is determined that the target temperature is reached prior to arriving at EVSE2 (however, the first traveling time is adjusted to a smaller value by the second adjustment time), wasteful power dissipation can be suppressed from occurring by not raising the temperature of the battery 100. When a sudden occurrence of a traffic jam, a reroute, or the like occurs and the first traveling time is extended, even when the temperature of the battery 100 is increased by the process A, the temperature increase of the battery 100 can be temporarily stopped by the process B. In addition, in a case where the first traveling time is shortened due to the resolving of the traffic jam, the rerouting, or the like, even in a case where the temperature of the battery 100 is not increased by the above-described process B, the temperature of the battery 100 can be immediately increased by the above-described process A.

ECU300 maintains the present condition of the temperature raising device 800 in S208 and returns the process to S200. That is, when the temperature raising device 800 is controlled to be in ON state in the previous cycle, the temperature raising device 800 is also controlled to be in ON state in the current cycle. When the temperature raising device 800 is controlled to be in OFF state in the previous cycle, the temperature raising device 800 is also controlled to be in OFF state in the current cycle.

As described above, when the value obtained by adding the first adjustment time to the first traveling time is equal to or more than the second traveling time and the value obtained by subtracting the second adjustment time from the first traveling time is equal to or less than the second traveling time (NO in S204 and NO in S206), ECU300 maintains the present state of the temperature raising device 800 (hereinafter, this process is referred to as "process C").

When the first traveling time frequently fluctuates due to a change in a traffic condition such as a traffic jam, there is a possibility that ON/OFF condition of the temperature raising device 800 is frequently switched by the process A, process B. However, by configuring the processing C as described above, it is possible to suppress such frequent switching (maintain the previous state) within the range of the first adjustment time plus the second adjustment time.

For example, the first adjustment time=10 minutes and the second adjustment time=10 minutes. As a result, it is possible to suppress such frequent switching in the range of 20 minutes. The first adjustment time and the second adjustment time may not be the same. In addition, the first adjustment time the second adjustment time>0 may be satisfied, and when this condition is satisfied, the first adjustment time may be a negative value, or the second adjustment time may be a negative value.

Further, as described above, ECU300 periodically acquires the first traveling time to be recalculated by the automotive navigation system 600 and recalculates the second traveling time. ECU300 updates the status of the temperature raising device 800 based on the recalculated first traveling time and the recalculated second traveling time.

By doing so, the first traveling time is constantly recalculated according to the current position of the vehicle 1, and the second traveling time is constantly recalculated according to the current battery temperature, so that the state of the temperature raising device 800 can be appropriately updated according to the situation. Thus, depending on the circumstances, when it is determined that the temperature increase is required for reaching the target temperature Tbt, the temperature raising device 800 is controlled to be in ON state, and when it is determined that the temperature increase is not necessary for reaching the target temperature Tbt, the temperature raising device 800 is controlled to be in OFF state. Accordingly, the temperature raising device 800 is controlled to reach the target temperature Tbt in the vicinity of the destination (EVSE2) as much as possible without unnecessarily controlling the temperature raising device ON. Therefore, the battery temperature of the vehicle 1 can be controlled so that wasteful power consumption does not occur.

Note that the second traveling time may be defined as a traveling time required to reach the target temperature by the heat generation of the battery 100 caused by the traveling of the vehicle 1 and the temperature rise control for controlling the temperature raising device 800 to ON condition. Here, ON/OFF of the temperature raising device 800 may be controlled so as to reach the destination when the vehicle travels for the second traveling time in the temperature-raising control mode.

The embodiment disclosed herein shall be construed as exemplary and not restrictive in all respects. The scope of the present disclosure is shown by the claims rather than by the above description of the embodiments and is intended to include all modifications within the meaning and scope equivalent to those of the claims.

What is claimed is:

1. A vehicle, comprising:
an externally chargeable battery;
a drive unit for driving the vehicle by electric power of the battery;
a temperature raising device for raising temperature of the battery;
a control device for controlling the temperature raising device; and
an automotive navigation system for performing guidance regarding a travel route and traveling time of the vehicle, from a current location to a destination, wherein
the control device
acquires from the automotive navigation system, when the destination is a charging facility of the battery, a first traveling time of the vehicle from the current location to the charging facility, and also calculates a second traveling time of the vehicle for the battery to reach a target temperature that is appropriate for charging in the charging facility, by heat generation of the battery due to the vehicle traveling, and
the temperature raising device is controlled to be in an on state based on results of comparison between the first traveling time and the second traveling time.

2. The vehicle according to claim 1, wherein the control device controls the temperature raising device to the on state when a value that is obtained by adding a first adjustment time to the first traveling time is smaller than a value of the second traveling time.

3. The vehicle according to claim 2, wherein the control device controls the temperature raising device to an off state when a value that is obtained by subtracting a second adjustment time from the first traveling time is greater than the second traveling time.

4. The vehicle according to claim 3, wherein the control device maintains a current state of the temperature raising device when the value that is obtained by adding the first adjustment time to the first traveling time is the second traveling time or greater, and also the value that is obtained by subtracting the second adjustment time from the first traveling time is the second traveling time or smaller.

5. The vehicle according to claim 1, wherein
the control device
periodically acquires the first traveling time to be recalculated by the automotive navigation system, and also recalculates the second traveling time, and
updates the state of the temperature raising device based on the first traveling time and the second traveling time that are recalculated.
